(19) United States
(12) Patent Application Publication
(10) Pub. No.: US 2015/0293294 A1
(43) Pub. Date: Oct. 15, 2015

(54) PORTABLE ELECTRICAL TERMINAL

(71) Applicant: HON HAI PRECISION INDUSTRY CO., LTD., New Taipei (TW)

(72) Inventor: SHAO-HAN CHANG, New Taipei (TW)

(21) Appl. No.: 14/497,019

(22) Filed: Sep. 25, 2014

(30) Foreign Application Priority Data
Apr. 11, 2014 (CN) 2014101440278

(51) Int. Cl. F21V 8/00

(52) U.S. Cl. CPC G02B 6/0028; G02B 6/0055; H04M 1/026

(57) ABSTRACT

A portable electrical terminal with inward illumination includes a main body and a back shell positioned on the main body. A light source portion is arranged on the main body. The back cover includes a light guide frame, a light guide plate and a light guide pipe. A first housing portion and a second housing portion are respectively located on opposite sides of the light guide frame. The light guide plate and card-shaped object can be received in the first housing portion. The light guide pipe is received in the second housing portion. The portable electrical terminal emits light for decoration and for close examination of the card-shaped object within the back shell arranged on the main body.

### FIELD

The subject matter herein generally relates to illumination of portable electrical terminal.

### BACKGROUND

Portable electrical terminals, such as mobile phones and tablet computers, are very popular. A portable electrical terminal can have decorative light for improving the appearance and warning users about calls and messages.

### BRIEF DESCRIPTION OF THE DRAWINGS

Implementations of the present technology will now be described, by way of example only, with reference to the attached figures.

FIG. 1 is an exploded, isometric view of an embodiment of a portable electrical terminal.

FIG. 2 is an isometric view of a separated main body and back cover of the portable electrical terminal of FIG. 1.

FIG. 3 is an isometric view of a light guide frame of the portable electrical terminal of FIG. 1.

FIG. 4 is an isometric view of the light guide frame of the portable electrical terminal of FIG. 1 from another perspective.

FIG. 5 is an isometric view of a light guide pipe of the portable electrical terminal of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “outside” refers to a region that is beyond the outermost confines of a physical object. The term “substantially” is defined to be essentially conforming to the particular dimension, shape, other feature that the term modifies, such that the component need not be exact. For example, “substantially cylindrical” means that the object resembles a cylinder, but can have one or more deviations from a true cylinder. The term “comprising, ” when utilized, means “including, but not necessarily limited to” ; it specifically indicates open-ended inclusion or membership in the so-described combination, group, series and the like.

The present disclosure describes a portable electrical terminal.

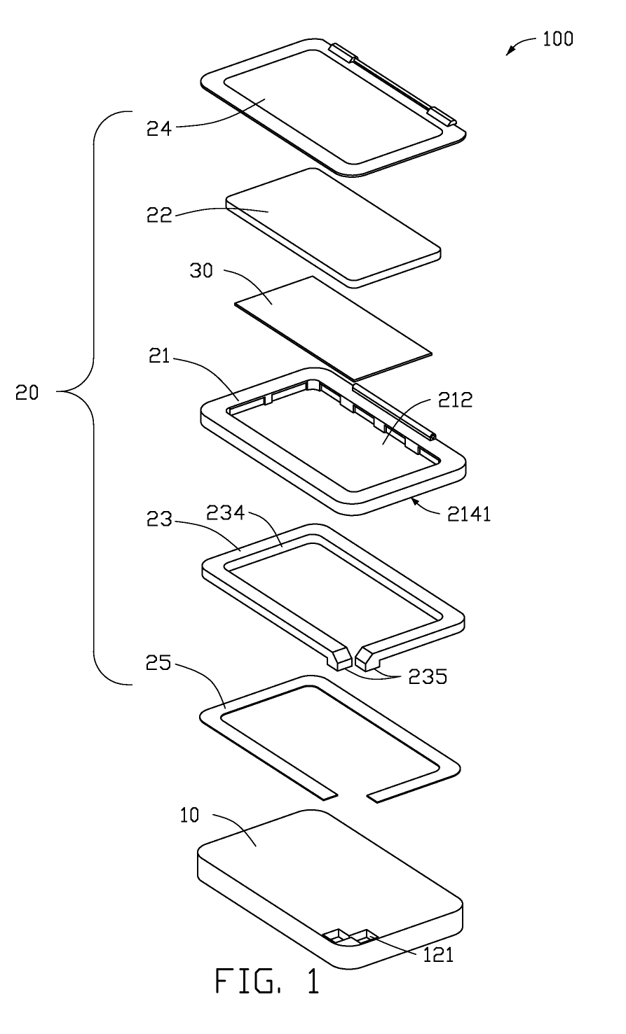

FIG. 1 illustrates a first embodiment of a portable electrical terminal 100. The portable electrical terminal 100 can include a main body 10 and a back shell 20 positioned on the main body 10. The main body 10 can include a light source portion 121. The back shell 20 can include a light guide frame 21, a light guide plate 22, and a light guide pipe 23. The light guide frame 21 can include a first housing portion 212 and a second housing portion 2141 respectively located on opposite sides of the light guide frame 21. The first housing portion 212 can receive the light guide plate 22 and other card-shaped objects 30. The second housing portion 2141 can receive the light guide pipe 23. The light guide pipe 23 can include two light incident portions 235 and a plurality of light-emitting portions 234 on an interior side-surface (not labeled) of the light guide pipe 23. The two light incident portions 235 can be received in, and optically couple with, the light source portion 121.

As described above, the back shell 20 can be positioned on the main body 10 of the portable electrical terminal 100. Although the housing portion 212 and the light guide pipe 23 can be positioned in the main body 10, the portable electrical terminal 100 can emit light and can receive the card-shaped objects 30 such as bank cards and pictures for the benefit of users. In addition, the light guide plate 22 can be positioned upon the card-shaped objects 30, and the card-shaped objects 30 can have a uniform luminous effect.

The back shell 20 can further include a outmost back cover 24, and a reflective sheet 25.

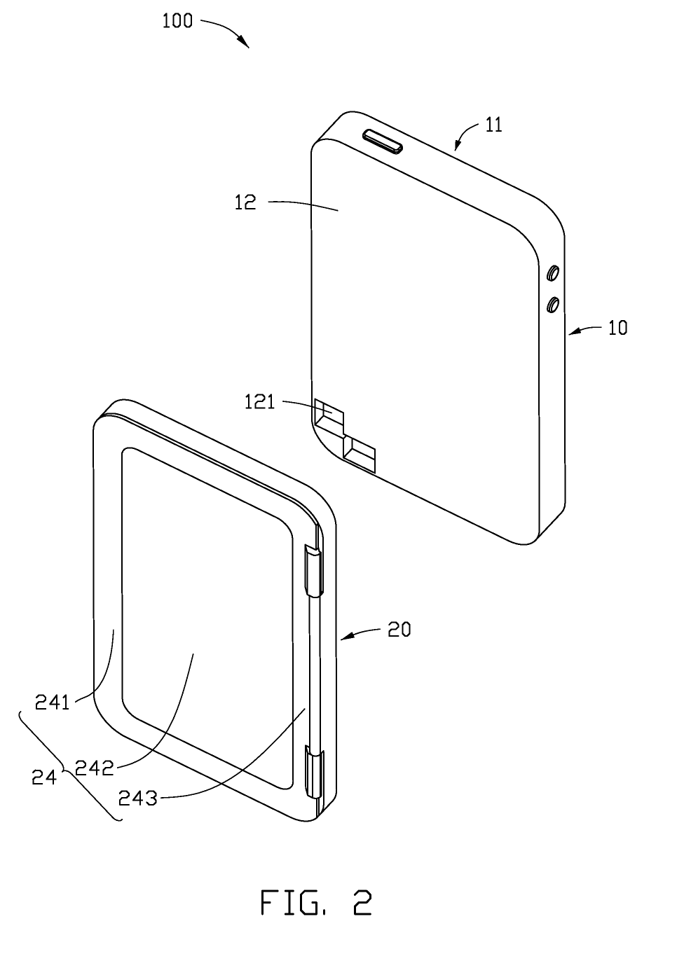

FIG. 2 illustrates that the main body 10 can further include a display screen 11, and a back surface 12 opposite to the display screen 11. The light source portion 121 can be positioned on the back surface 12 and be configured to emit light to the outside of the main body 10. The light source is not shown. The light source portion 121 can be a groove. The back shell 20 can be positioned on the back surface 12 of the main body 10. The back shell 20 and the main body 10 have the same shape.

The back cover 24 can be a rectangular plate, and can include a shading portion 241, a light transmitting portion 242 circled by the shading portion 241, and a shaft portion 243 located at a side of the back cover 24. The shading portion 241 can be formed at the periphery of the back cover 24 by means of composite forming, film pasting, printing, or other process. The shaft portion 243 can be rotatably connected to the light guide frame 21 (shown in FIG. 1).

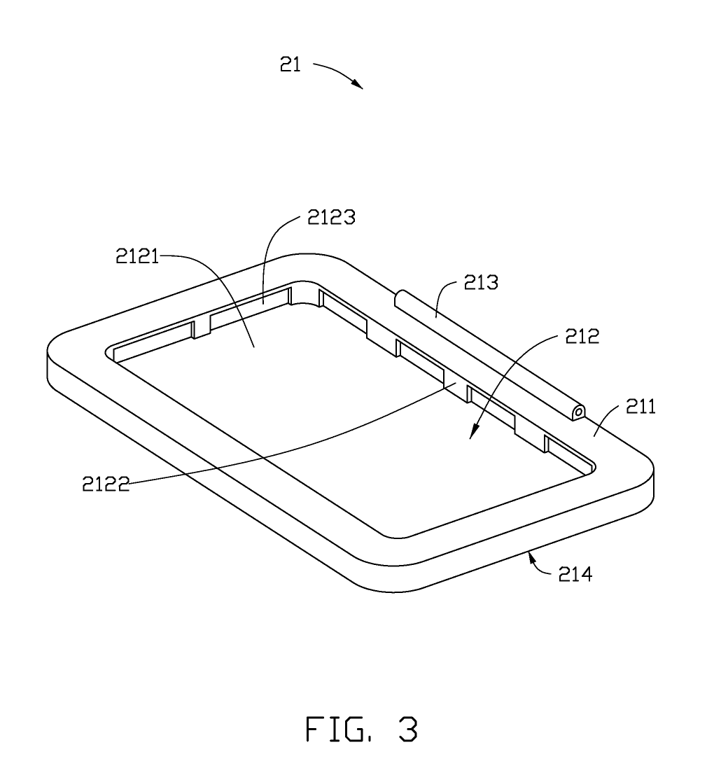

FIG. 3 illustrates that the light guide frame 21 can be a rectangular frame, and can further include a first upper surface 211 and a first lower surface 214 opposite to the first upper surface 211. The first housing portion 212 can be positioned on the center of the first upper surface 211. The first upper surface 211 can further include a connecting portion 213 located at one edge of the first upper surface 211. The first housing portion 212 can be a rectangle, and can include a bottom surface 2121, a plurality of sidewalls 2122 vertically extending from sides of the bottom surface 2121, and at least one light transmitting hole 2123 defined in the plurality of sidewalls 2122. The light transmitting holes 2123, if more than one, can be spaced from each other. The shape of the light transmitting holes 2123 can be rectangular or circular. The connecting portion 213 can be rotatably connected with the shaft portion 243 (shown in FIG. 2).

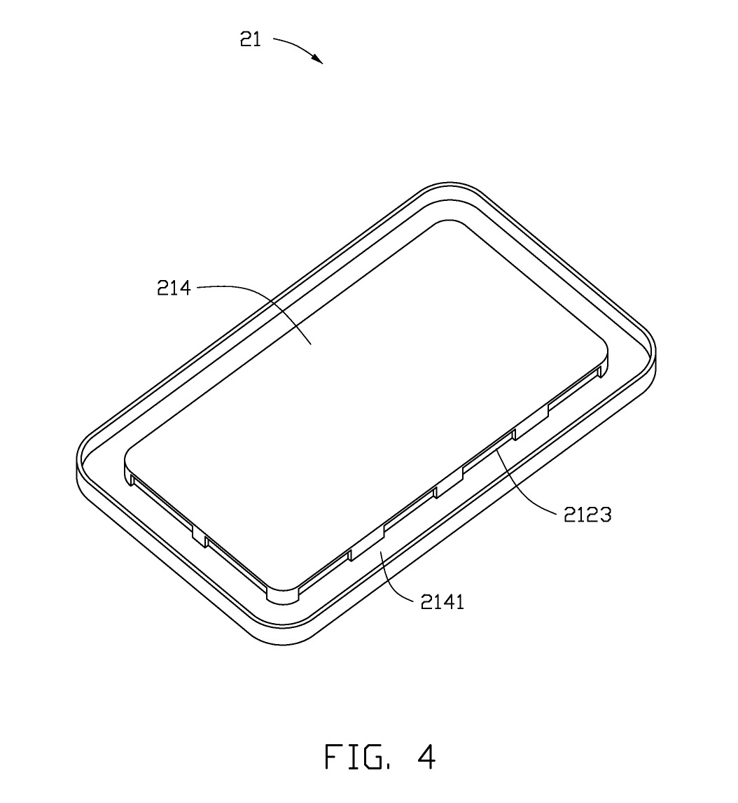

FIG. 4 illustrates that the second housing portion 2141 can be positioned on and located at the periphery of the lower surface 214. The second housing portion 2141 can circle the first housing portion 212, and can be in communication with the first housing portion 212 by the light transmitting holes 2123 (shown in FIG. 3). The inner surface (not labeled) of the second housing portion 2141 can be coated with a high-reflection layer (not labeled) for reducing light loss. The reflectivity of the coating layer is above 0.9.

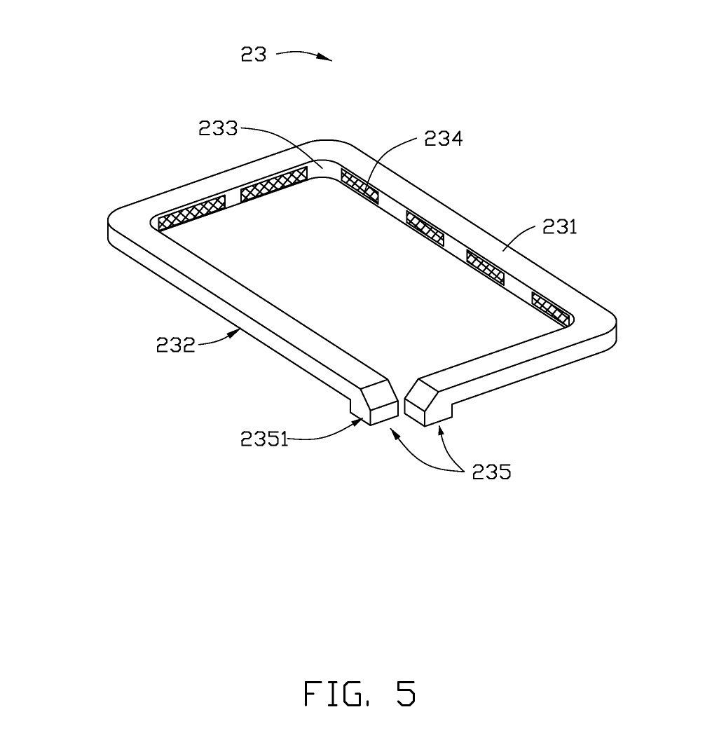

FIG. 5 illustrates that the light guide pipe 23 can be a bar-shaped frame with an opening (not labeled). The light guide pipe 23 can further include a second upper surface 231, a second lower surface 232 opposite to the second upper surface 231, and an interior side-surface 233 connected with the second upper surface 231 and second lower surface 232. The reflective sheet 25 (shown in FIG. 1) can be attached to the second lower surface 232 for reducing the light loss of the light guide 23. The light-emitting portions 234 can be spaced from each other on the interior side-surface 233 of the light guide pipe 23, and can correspond to the light-emitting holes 2123. The light entering into the light guide pipe 23 can be uniformly dispersed on the each light-emitting portion 234 by, for example, micro-lenses (not shown) positioned on the light-emitting portions 234, or increasing the surface roughness of the light-emitting portions 234. The two light incident portions 235 can be defined by perpendicular extensions from two ends of the opening (not labeled). Each of light incident portions 235 can include a light incident surface 2351 parallel to the second lower surface 232. The two light incident portions 235 can be received in, and optically coupled with, the light source portion 121 (shown in FIG. 2).

In assembly, the light guide pipe 23 can be received in the second housing portion 2141, and the light-emitting portions 234 installed to correspond with the light-emitting holes 2123 of the light guide frame 21. The reflective sheet 25 can be positioned upon the second lower surface 232. Then the card-shaped objects 30 can be received in the first housing portion 213, and the light guide plate 22 can be stacked upon the card-shaped objects 30. Then the shaft portion 243 of the back cover 24 can be rotatably connected with the connecting portion 213 of the light guide frame 21. Finally, the light incident portion 235 of the back shell 20 can be received in and optically coupled with the light source portion 121 of the main body 10.

To examine a new card-shaped object 30, the back cover 24 can be opened, and the light guide plate 22 can be taken out from the first housing portion 212. Then the old card-shaped object 30 can be taken out from the first housing portion 212, and the new other card-shaped object 30 can be received in the first housing portion 212. The light guide plate 22 is placed over the new card-shaped object 30, and the back cover 24 can cover the light guide frame 21.

In use, the light from the light source 121 of the main body 10 can be transmitted into the light guide pipe 23 through the light incident surface 2351 of the light incident portion 235, and the light entering into the light guide pipe 23 can be transmitted into the first housing portion 212 through the light-emitting portions 234 and the light-emitting holes 2123. The light entering into the first housing portion 212 can be uniformly dispersed in the first housing portion 212 by the light guide plate 22 , and a card-shaped object 30 can have a uniform luminous effect. Finally, the light transmitting potion 242 of the back cover 24 provides lighting from the first housing portion 212 to the outside environment.

In other embodiment, transparent card-shaped objects 30 can also be internally illuminated by the light guide plate 22.

The embodiments shown and described above are only examples. Many details are often found in the art such as the other features of a portable electrical terminal. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A portable electrical terminal, comprising:
a main body comprising a light source portion;
a back shell positioned on the main body and comprises:
a light guide frame comprising a first housing portion and a second housing portion respectively located on opposite sides of the light guide frame;
a light guide plate received in the first housing portion; and
a light guide pipe comprising a light incident portion and a light-emitting portion on an interior surface of the light guide pipe; wherein the light incident portion is received in and optically matched with the light source portion.

2. The portable electrical terminal as claimed in claim 1, wherein the light guide frame further comprises a first upper surface, a first lower surface opposite to the first upper surface, and a connecting portion located at the one edge of the first upper surface.

3. The portable electrical terminal as claimed in claim 2, wherein the first housing portion is positioned upon the center of the first upper surface.

4. The portable electrical terminal as claimed in claim 2, wherein the second housing portion is positioned on and located at the periphery of the first lower surface .

5. The portable electrical terminal as claimed in claim 1, wherein the second housing portion circles the first housing portion.

6. The portable electrical terminal as claimed in claim 1, wherein the inner surface of the second housing portion is coated with a high-reflection layer.

7. The portable electrical terminal as claimed in claim 1, wherein the first housing portion comprises a bottom surface, a plurality of sidewalls vertically extending from sides of the bottom surface, and at least one light transmitting hole defined in the plurality of sidewalls; the light transmitting holes pass through the first housing portion and the second housing portion.

8. The portable electrical terminal as claimed in claim 7, wherein the light-emitting portion corresponds to the light-emitting holes.

9. The portable electrical terminal as claimed in claim 1, wherein the light guide pipe is a bar-shaped frame with an opening.

10. The portable electrical terminal as claimed in claim 1, wherein the light guide pipe further comprises a second upper surface, a second lower surface opposite to the second upper surface, and an interior side-surface connected with the second upper surface and second lower surface.

11. The portable electrical terminal as claimed in claim 10, wherein the light-emitting portion is spaced from each other on the interior side-surface of the light guide pipe.

12. The portable electrical terminal as claimed in claim 10, wherein the back shell further includes a back cover and a reflective sheet; the reflective sheet is attached to the second lower surface.

13. The portable electrical terminal as claimed in claim 12, wherein the back cover include a shading portion, a light transmitting portion circled by the shading portion, and a shaft portion located at a side of the back cover; the shaft portion is rotatably connected with the connecting portion.

14. The portable electrical terminal as claimed in claim 1, wherein the two light incident portion are defined by perpendicular extensions from two ends of the opening.

15. The portable electrical terminal as claimed in claim 1, wherein the light source portion is a groove for receiving the light incident portions.
